(19) United States
(12) Patent Application Publication
(10) Pub. No.: US 2010/0206936 A1
(43) Pub. Date: Aug. 19, 2010

(54) CRAFT STAPLER AND CRAFT STAPLES USED FOR THE SAME

(75) Inventor: Wan-Young OH, Seoul (KR)

Correspondence Address: STEIN MCEWEN, LLP, 1400 EYE STREET, NW, SUITE 300, WASHINGTON, DC, 20005, US

(73) Assignee: DN Craft Corporation, Seoul (KR)

(21) Appl. No.: 12/372,260

(22) Filed: Feb. 17, 2009

(51) Int. Cl. B25C 5/00

(52) U.S. Cl. 227/139

(57) ABSTRACT

A craft stapler stapling a sheet material using a staple having an upper pattern body and legs extending downward from both ends of the upper pattern body, the craft stapler comprising: a lower base provided with an anvil having a forming groove to fold ends of the legs of the craft staple; a punching unit including a punching block pressing the staple the sheet material by moving up and down with respect to the anvil; and a magazine positioned between the lower base and the punching unit and having a magazine hole to receive the staple from the top, the punching block passing through the magazine hole.

### BACKGROUND OF THE INVENTION

1. Field of the Invention

The present invention relates to a craft stapler for stapling the sheet material such as a paper and post cards with various kinds of patterns for ornament and craft staples adopted by the stapler.

2. Description of the Related Art

In general, a stapler is used to bind a stack of sheet by folding a staple behind the sheet. The conventional stapler adopts staples integrally formed made of steel and separated one by one by stapling against the sheet.

However, the convention stapler is directed to just binding a stack of paper but nothing to do with ornament of paper.

Recently, there is a demand that a stapler and staples shall be configured to ornament the sheet as well as binding the same.

### SUMMARY OF THE INVENTION

The present invention is designed to meet the above demand. It is an object of the invention to provide craft staples by which a sheet may be stapled in various kinds of patterns and a craft stapler using the staples.

In order to accomplish the above object, the present invention provides a craft stapler stapling a sheet material using a staple having an upper pattern body and legs extending downward from both ends of the upper pattern body, the craft stapler comprising: a lower base provided with an anvil having a forming groove to fold ends of the legs of the craft staple; a punching unit including a punching block pressing the staple the sheet material by moving up and down with respect to the anvil; and a magazine positioned between the lower base and the punching unit and having a magazine hole to receive the staple from the top, the punching block passing through the magazine hole.

Preferably, the magazine hole is provided with vertical guide grooves to receive and guide at least portion of the legs of the craft staple.

The invention further comprises a jig provided on the magazine plate, and the magazine hole is formed on the jig.

More preferably, the magazine plate is made of transparent material.

According to another aspect of the present invention, there is provided a craft staple comprising: an upper pattern body shaped in the form of a predetermined pattern; guide protrusions protruding laterally from both ends of the upper pattern body to have a width smaller than the width of the upper pattern body; and a pair of legs extending downward from the guide protrusion.

According to another aspect of the present invention, there is provided a craft staple comprising: an upper pattern body shaped in the form of a predetermined pattern; a pair of legs extending downward from both ends of the upper pattern body; and guide embossments or guide recesses formed on the legs.

### BRIEF DESCRIPTION OF THE DRAWINGS

These and/or other aspects and advantages of the invention will become apparent and more readily appreciated from the following description of the embodiments, taken in conjunction with the accompanying drawings of which.

FIG. 1 is a perspective view showing a craft stapler according to a preferred embodiment of the present invention;

FIG. 2 is an exploded perspective view showing a craft stapler according to a preferred embodiment of the present invention;

FIG. 3 is a perspective view showing a craft staple is loaded on a magazine plate according to a preferred embodiment of the present invention;

FIG. 4 is a perspective view showing a craft staple according to the preferred embodiment of the present invention;

FIG. 5 is a perspective view showing a craft staple is loaded on a magazine plate according to another preferred embodiment of the present invention;

FIG. 6 is a perspective view showing a craft staple according to another preferred embodiment of the present invention;

FIG. 7 is a perspective view illustrating the operation of the craft stapler according to the preferred embodiment of the present invention;

FIGS. 8 to 10 are views showing various patterns obtained from craft staples according to the preferred embodiment of the present invention; and

FIG. 11 is a perspective view illustrating the configuration of a craft staple according to the preferred embodiment of the present invention.

### DETAILED DESCRIPTION OF THE EMBODIMENTS

Hereinafter, preferred embodiments of the present invention will be described in detail with reference to the accompanying drawings. However, it should be understood that the terms in the description and the appended claims should not be construed as limited to general and dictionary meanings, but interpreted based on the meanings and concepts corresponding to technical aspects of the present invention on the basis of the principal that the inventor is allowed to define terms appropriately as a lexicographer.

Therefore, the embodiments herein are just preferable examples for the purpose of illustrating the invention, not intended to limit the scope of the invention, so it should be under stood that other equivalents and modifications could be made thereto without departing from the spirit and scope of the invention.

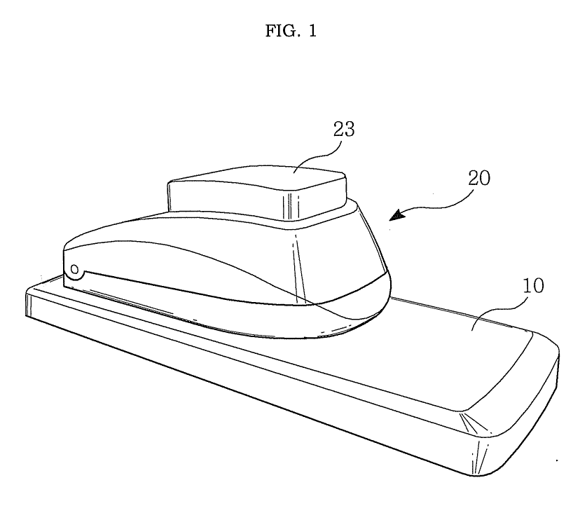

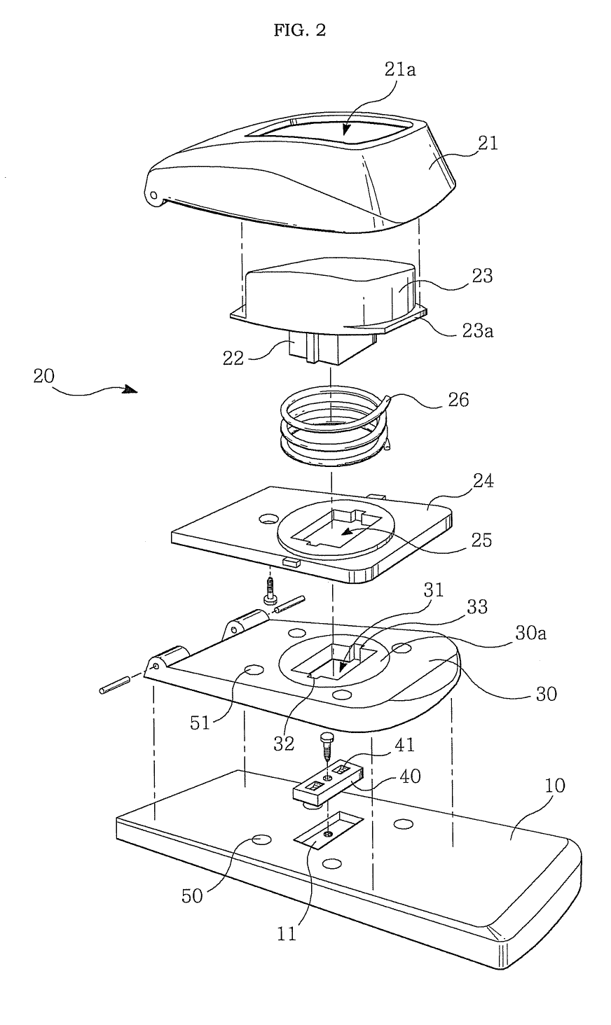

FIGS. 1 and 2 show a craft stapler according to a preferred embodiment of the present invention. The craft stapler punches paper, letters or post cards (hereinafter referred as ‘a sheet material’) with craft staples of predetermined patterns.

Referring to the drawings, the craft stapler of the present invention comprises a lower base 10 providing a flat plane on which a sheet material is placed, a punching unit 20 including a punching mechanism for punching a staple against the sheet material inside, and a magazine plate 30 interposed between the lower base 10 and the punching unit 20.

The lower base 10 comprises a flat plate formed with a recess 11 in which an anvil 40 rests.

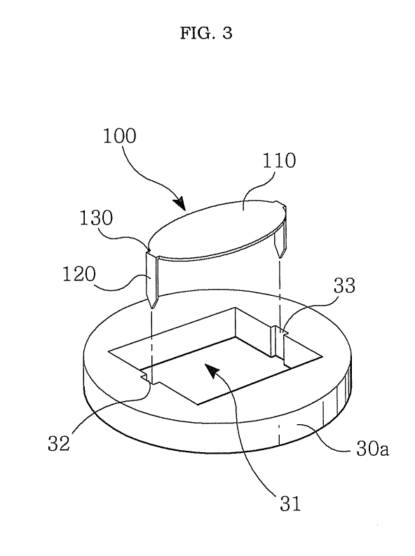

The anvil 40 has a forming groove 41 formed on the upper surface thereof to fold legs (see 120 of FIG. 3) extending at both ends of the staple as set forth later. It is preferable that the forming groove 41 is concaved smoothly round in order to fold the legs 120 of the staple upon pressed by the craft stapler.

The punching unit 20 comprises a housing 21 and a punching block 22 contained in the housing 21. The punching block 22 moves up and down to press the staple. Preferably, a press member 23 is provided on the upper portion of the punching block 22 to press it.

The housing 21 also has an opening 21a on the top so that the upper portion of the press member 23 is exposed out of the housing 21 through the opening 21a. Since a stop flange 23a formed on the circumferential outer surface at the lower end of the press member 23 connects with the housing 21, the press member 23 and the punching block 22 can be maintained in the housing 21 not to pop out.

Although the punching block 22 and the press member 23 is provided separately, but not limited thereto so that they may be formed integrally in alternative embodiment.

The punching block 22 is contained in the housing 21 to be forced upward elastically. In doing so, a support 24 is installed on the lower portion of the punching block 22 while an elastic member 26 such as a spring are interposed between the punching block 22 and the support 24 to elastically bias the punching block 22 upward.

Also, the support 24 has a guide hole 25 for guiding the movement of the punching block 22 passing through the guide hole 25.

The stapler of the present invention comprises a magazine plate 30 which is interposed between the lower base 10 and the punching unit 20. The magazine plate 30 receives the staple to be stapled against the sheet material and guiding the staple moving up and down too.

Specifically, the magazine plate 30 is formed with an opening on which a jig 30a rests. The jig 30a has a magazine hole 31 to receive the staple and through which the punching block 22 passes. The magazine hole 31 is positioned above the anvil 40 so that the legs 120 of the staple loaded on the magazine hole 31 are smoothly folded by the forming groove 41 of the anvil 40 upon pressed by the punching unit.

Although not shown in the drawings, the magazine hole 31 may be formed in the magazine plate 30 without the jig 30a in the alternatives.

Preferably, the magazine plate is made of transparent material such as polycarbonate or glass, so that a user is able to see the sheet material under the magazine plate, which facilitates a positioning of the staple.

Alternatively, the magazine plate 30 may be made of an opaque material.

According to the present invention, the magazine plate 30 is connected to the housing 21 by a hinge, but not limited to this. For example, the magazine plate 30 is pivotally connected to the base 10 or the support 24.

Alternatively, the magazine plate 30 may be configured separately and detachably attached to one of the housing 21, the support 24 or the lower base 10 by, for example, magnets.

The magazine plate 30 may be modified to various configurations by those skilled in the art as long as it can achieve the function of supporting the staple and having the sheet material supplied between the magazine plate and the lower base.

The sheet material to be stapled is interposed between the magazine plate 30 and the lower base 10. In this regard, a plurality of magnets 50 and 51 may be provided on the position facing each other in the lower base 10 and the magazine plate 30 to facilitate the alignment of the magazine plate 30 and the lower base 10.

Although not described in detail, in case the magazine plate 30 is separately provided from the housing 21 or the support 24, the magazine plate 30 may be attached to the housing 21 or the support 24 by magnets installed on the housing 21 or the support 24.

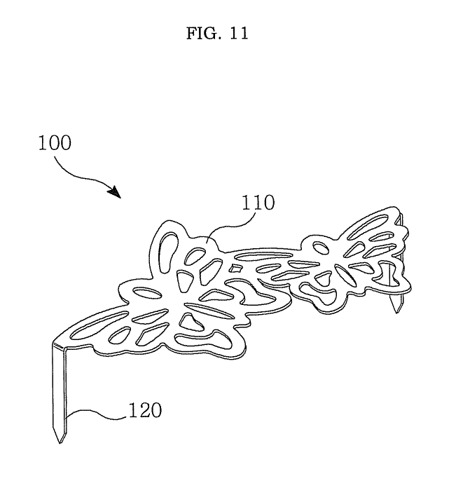

A craft staple used in the craft stapler according to the preferred embodiment of the present invention is shown in FIG. 11. FIG. 3 is a perspective view schematically illustrating a craft staple 100 and the jig 30a having the magazine hole 31 for convenience of view.

The craft staple 100 of the invention comprises an upper pattern body 110 in the form of various patterns, and a pair of legs 120 extending downward from both ends of the upper pattern body 110.

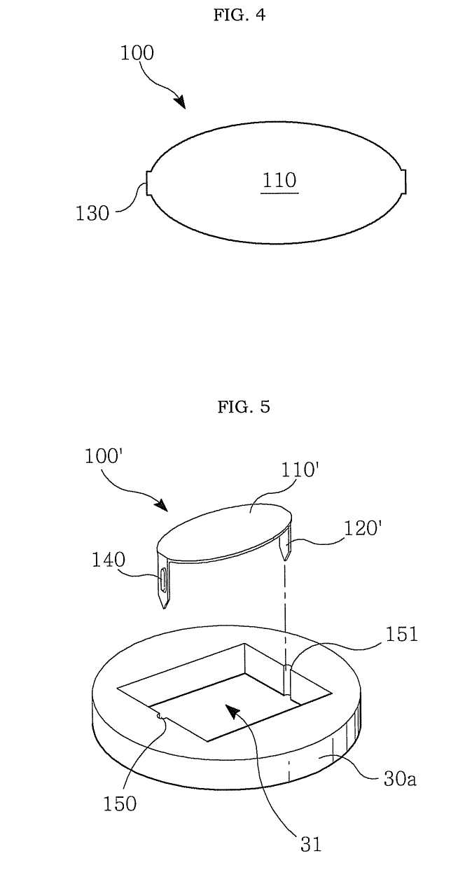

Preferably, as shown in FIG. 4, the legs 120 extends downward from a guide protrusion 130 which protrudes laterally from the both ends of the upper body 110 by a predetermined distance. Here, ‘the both ends’ of the upper body 110 denotes the most left end and the most right end of the upper pattern body 110, or the intersections of the boundary of the upper pattern body 110 and the longest line passing through the center of the upper pattern body 110, but not limited to this.

The guide protrusion 130 links the upper pattern body 110 with the legs 120, and it has a width corresponding to guide grooves (see 32 and 33 of FIG. 2) to be inserted that is smaller than the width of the upper pattern body relatively.

Preferably, the legs 120 have a sharpened end to make it easy to penetrate the sheet material.

The craft staple of the present invention may be made in various methods, for example, by pressing out a metal sheet to have the upper pattern body and the legs and bending the legs to form the guide protrusion, but not limited thereto.

Referring to FIG. 2, vertical guide grooves 32 and 33 are formed on the inner surface of the magazine hole 31 to insert the legs 120 and the guide protrusion 130 from the above. Preferably, the guide grooves 32 and 33 have a size sufficient to receive the legs 120 and the guide protrusion 130 fully.

It should be understood that the guide protrusion 130 is a part of the legs 120 though the guide protrusion 130 is described separate from the legs 120.

In addition, although the guide protrusion 130 is positioned between the upper pattern body 110 and the legs 120, it may be formed on the middle or other portion of the upper pattern body 110, but not limited thereto.

Accordingly, the guide protrusion 130 is considered to be a part of the legs 120, and the guide grooves 32 and 33 receive such a part of the legs 120.

According to the invention, the craft staple 100 is loaded in the magazine hole 31 downward from the top so that the guide grooves 32 and 33 are formed in the vertical direction on the inner surface of the magazine hole 31.

With the above configuration, the craft staple 100 is loaded in the magazine hole 31 such that the guide protrusion 130 and the legs 120 are inserted into the guide grooves 32 and 33, which makes the craft staple 100 stable.

In such a state, the legs 120 and the guide protrusion 130 are guide by the guide grooves 32 and 33 of the magazine hole 31 when the craft staple 100 is pressed by the punching block 22.

As the craft staple 100 moves down, the sharpened ends of legs 120 penetrate the sheet material and are folded by the forming groove 41 of the anvil 40 to thereby clamp the sheet material.

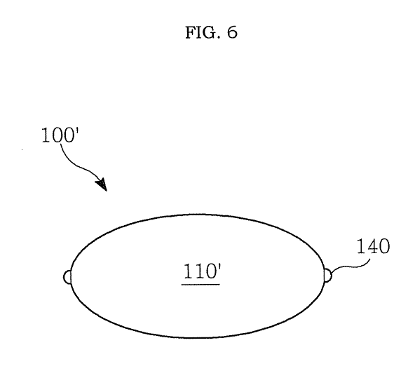

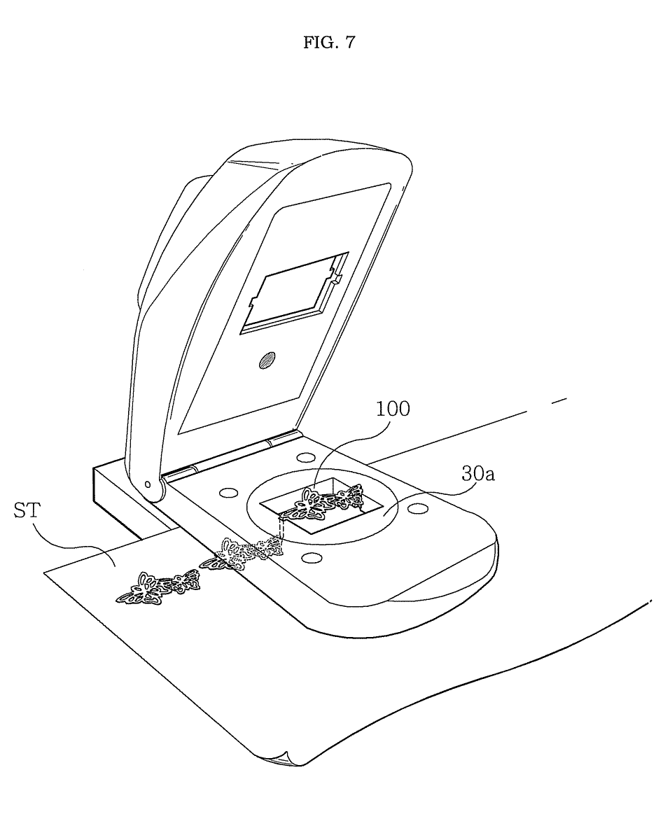

FIGS. 5 and 6 show views a craft staple 100′ according to another embodiment of the present invention. Here, like numeral references denote the like elements as the previous drawings.

A craft staple 100′ of the present invention comprises legs 120′ extending downward from both ends of the upper pattern body 110′. The staple 110′ is not provided with the guide protrusion (130 of FIG. 4) between the upper pattern body 110′ and the legs 120′, which is different from the previous embodiment.

Instead, a guide embossment 140 is formed on the outer surface of the legs 120′.

Also, the magazine hole 31 has guide recesses 150 and 151 to receive the guide embossments 140 on the inner surface thereof. The guide recesses 150 and 151 are shaped corresponding to the shape of the guide embossment 140.

Accordingly, the craft staple 100′ is loaded in the magazine hole 31 such that the guide embossments 140 are inserted into the guide recesses 150 and 151. When the craft staple 100′ is pressed downward by the punching block 22, the guide embossments 140 move along the guide recesses 150 and 151 to be guided thereby for stable movement and binding the sheet material.

Alternatively, the magazine hole 31 may have a guide embossment at the inner surface thereof and the legs 120 may have a guide recess corresponding to the guide embossment.

Now the operation of the present invention having the above configuration will be described below.

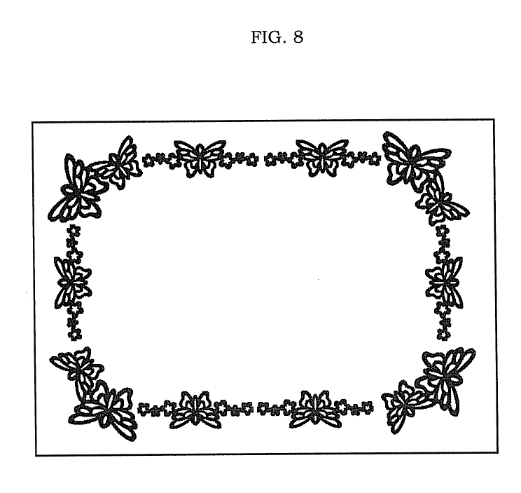

FIG. 7 illustrates a sheet material ST to be stapled by stapling consecutively with the staple 100 loaded in the magazine hole 31 of the jig 30a.

First, the sheet material ST to be stapled is placed on the lower base 10 of FIG. 2. At this time the punching unit 20 and the magazine plate 30 are separated from the lower base 10.

Then, the magazine plate 30 is placed on the sheet material ST upon aligning the sheet material ST. Here, the magazine plate 30 may be attached onto the lower base 10 with the sheet material ST interposed between them by means of the magnets 50 and 51 provided on the lower base 10 and the magazine plate 30.

Next, a craft staple 100 having a desired pattern is loaded in the magazine hole 31 of the magazine plate 30 so that the guide protrusion 130 of the staple 100 is received by the guide grooves 32 and 33 on the inner surface of the magazine hole 31.

In the case of the embodiment shown in FIGS. 5 and 6, the guide embossments 140 of the legs 120′ are received by the guide recesses 150 and 151 of the magazine hole 31.

With the sheet material ST is positioned between the lower base 10 and the magazine plate 30, a user presses the press member 23 to move the punching block 22 down, and then the craft staple 100 is pressed by the punching block 22 to move down with the guidance of guide grooves 32 and 33 or guide recesses 150 and 151.

Then, legs 120 of the craft staple 100 penetrate the sheet material ST and are folded by the forming groove 41 of the anvil 40 to thereby clamp the sheet material ST.

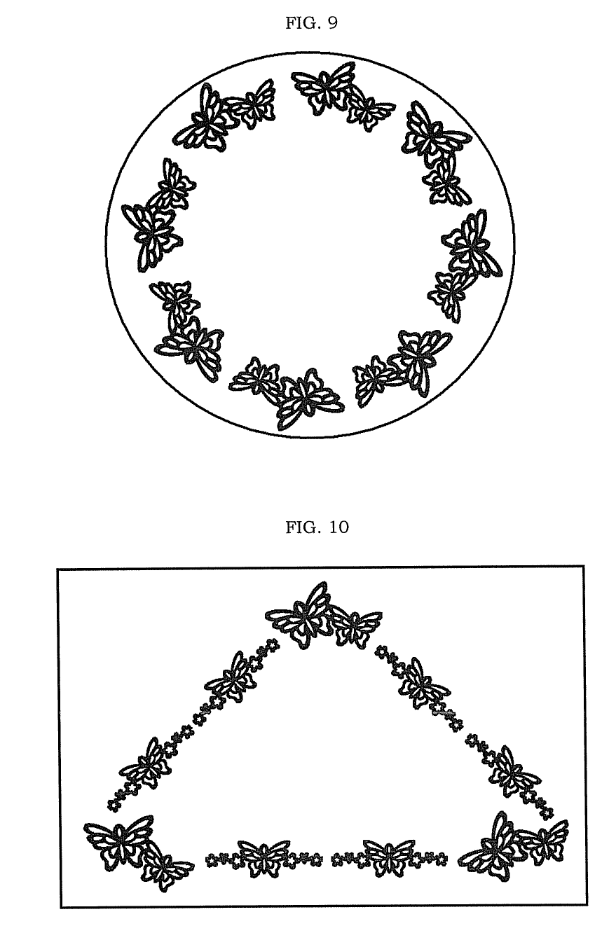

FIGS. 8 to 10 are views showing the sheet material ST stapled using the craft staples having various patterns according to the present invention.

In the craft stapler of the invention, the punching unit 20 is separated from the lower base 10, so that the sheet material is able to be stapled at any position with staples regardless of the shape of the sheet material.

Also, it is so easy to attach the magazine plate 30 to the lower base 10 by providing magnets thereon.

The magazine plate 30 is made of transparent materials to enable a user to see the sheet material under the magazine plate for alignment of the sheet material.

Further, it makes a user to ornament the sheet material as desired as well as binding sheets by the stapler and staples of the present invention.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A craft stapler stapling a sheet material using a staple having an upper pattern body and legs extending downward from both ends of the upper pattern body, the craft stapler comprising:
a lower base provided with an anvil having a forming groove to fold ends of the legs of the craft staple;
a punching unit including a punching block pressing the staple the sheet material by moving up and down with respect to the anvil; and
a magazine positioned between the lower base and the punching unit and having a magazine hole to receive the staple from the top, the punching block passing through the magazine hole.

2. The craft stapler according to claim 1, wherein the magazine hole is provided with vertical guide grooves to receive and guide at least portion of the legs of the craft staple.

3. The craft stapler according to claim 2, further comprising a jig provided on the magazine plate, and wherein the magazine hole is formed on the jig.

4. The craft stapler according to claim 2, wherein the magazine plate is made of transparent material.

5. The craft stapler according to claim 1, wherein the magazine hole is provided with vertical guide recesses or guide embossments to guide at least portion of the legs of the craft staple.

6. The craft stapler according to claim 5, further comprising a jig provided on the magazine plate, and wherein the magazine hole is formed on the jig.

7. The craft stapler according to claim 5, wherein the magazine plate is made of transparent material.

8. The craft stapler according to claim 1, wherein the magazine plate is configured to be detachably installed to the lower base.

9. The craft stapler according to claim 8, further comprising a jig provided on the magazine plate, and wherein the magazine hole is formed on the jig.

10. The craft stapler according to claim 8, further comprising magnets provided on the magazine plate and the lower base to attach each other.

11. The craft stapler according to claim 8, wherein the magazine plate is made of transparent material.

12. The stapler according to claim 1, wherein the punching unit is configured to be detachably installed to the lower base.

13. The craft stapler according to claim 12, further comprising a jig provided on the magazine plate, and wherein the magazine hole is formed on the jig.

14. The craft stapler according to claim 12, further comprising magnets provided on the punching unit and the lower base to attach each other.

15. The craft stapler according to claim 12, wherein the magazine plate is made of transparent material.

16. The craft stapler according to claim 1, further comprising a jig provided on the magazine plate, and wherein the magazine hole is formed on the jig.

17. The craft stapler according to claim 1, wherein the magazine plate is made of transparent material.

18. A craft staple comprising:
an upper pattern body shaped in the form of a predetermined pattern;
guide protrusions protruding laterally from both ends of the upper pattern body to have a width smaller than the width of the upper pattern body; and
a pair of legs extending downward from the guide protrusion.

19. A craft staple comprising:
an upper pattern body shaped in the form of a predetermined pattern;
a pair of legs extending downward from both ends of the upper pattern body; and
guide embossments or guide recesses formed on the legs.
